(19) United States
(12) Patent Application Publication
(10) Pub. No.: US 2010/0133335 A1
(43) Pub. Date: Jun. 3, 2010

(54) SYSTEM AND METHOD FOR MOBILE PAYMENT

(76) Inventors: Hazem Abdel Maguid, Ottawa (CA); George Tzavelas, Ottawa (CA)

Correspondence Address: VINCENT PATENT AGENCY, 11-300 EARL GREY DRIVE, SUITE 202, KANATA, ON, K2T 1C1, CA

(21) Appl. No.: 12/324,982

(22) Filed: Nov. 28, 2008

(51) Int. Cl. G06K 5/00

(52) U.S. Cl. 235/380

(57) ABSTRACT

A system and method for mobile payment. The system and method provide for a user of a mobile telephony device (MTD), having an affixed wireless identification tag, to make payments, and other similar financial transactions, by presenting the MTD at a point-of-sale (POS), or equivalent, and by providing a confirmation, including a personal identification number, to complete the financial transaction via a data communication infrastructure (e.g. Unstructured Supplementary Service Data (USSD)) supported by the MTD.

### FIELD OF INVENTION

The present invention relates to the field of mobile commerce. In particular, to an apparatus and a method for performing financial transactions using a mobile telephony device.

### BACKGROUND

A traditional commerce transaction takes place with a product or service being purchased using one of the following payment methods: cash, check, prepaid card, debit card or credit card. Cash and check payments are the most versatile as they do not require a merchant to have any special equipment to process a transaction. A disadvantage of using cash or check is the inherent anonymity they offer since if they are lost or stolen, anyone else can easily make use of them. Prepaid cards offer the consumer ease of use since they function like cash and prevent the user from accumulating debt. Unfortunately many prepaid cards burden the consumer with usage charges and as with cash or check, if lost or stolen they can be used by anyone very easily. Credit and debit cards are increasingly becoming the payment method of choice for the consumer since they offer some security (PIN number for debit card and signature for credit card) and most offer the consumer loyalty benefits that can be redeemed for the purchase of other goods. The downside to using credit or debit cards is that anonymity is lost since the consumer's name, affiliated financial institution and account number become visible to anyone witnessing the transaction.

Mobile commerce is the ability for a consumer to conduct commerce electronically using a mobile phone. Performing a complete transaction electronically offers both the consumer and the merchant a quick and simple way to engage in commerce. In addition, empowering a consumer to purchase goods and services using a mobile phone is the next logical step for personal commerce given the ubiquitous presence of mobile phones today. Mobile phones can also give the consumer an added level of security since a lost or stolen mobile phone can be disabled or even tracked with minimal effort and a consumer will more quickly notice a missing mobile phone than most other personal effects.

There are three main methods by which a mobile phone can be used to facilitate mobile commerce, they are: Quick Response (QR) codes, Short Message Service (SMS), and proximity technology

QR codes are two-dimensional codes in the form of a picture that has been widely adopted in Japan. QR codes allow consumers to read or scan the code's information with their mobile phone and be directed to a URL specifically formatted for mobile access where the consumer can download or buy an item. This technology requires the mobile phone to be equipped with a QR reader and is limited in scope since a QR code must be available for each item (or group of items) the merchant wishes to sell.

SMS capability is a feature built-in to almost every cell phone and can be adapted rather easily to perform mobile commerce. Typically the merchant sends an authorize payment request to the consumer (subscriber) by composing an SMS message contains the following: *AC1*MSISDN*Amount*PIN#

Where

AC1: is a short code for a specific service.

MSISDN: Consumer Mobile Number

Amount: Amount to be authorized.

PIN: Merchant Password

Once authenticated by the operator, the subscriber receives an SMS message and then the subscriber replies to the Message and enters his PIN to authenticate and complete the transaction.

The main drawbacks of SMS technology include:
The inherent “send and forget” architecture of the SMS messaging system since it is based on “Stored and forward” technology. So that if either the merchant's or the consumer's SMS message fails to be forwarded by the operator, the transaction will fail.
Security, the SMS is not a secure medium for transmitting financial transaction. It has no encryption and no tie to the Subscriber Identification Module (SIM) or Mobile Subscriber Integrated Services Digital Network Number (MSISDN).
Passwords are saved in the SMS logs as plain text.
Another factor to consider is the lack of consumer privacy for SMS based transactions since the consumer's mobile number must be given to the merchant for the transaction to take place.

“Proximity” or short-range radio technology allows a mobile phone to securely communicate information from an embedded Radio Frequency Identifier (RFID) to a Point-of-Sale (POS) device. The merchant will initiate a transaction by entering (manually or by scanner) the goods and/or services designated by the consumer. Next the consumer brings their mobile phone within close proximity to the POS device and the financial information (e.g. credit card number, mWallet or bank account number) is communicated to the POS. Once authenticated, the consumer is prompted to enter his Personal Identification Number (PIN) to authenticate and complete the transaction.

Near Field Communication (NFC) is one of the more popularly proposed solutions for proximity based mobile commerce. NFC has the backing of many financial institutions and mobile phone manufacturers. Unfortunately it will take many years for this technology to be adopted by the consumer since it requires a specific NFC enabled mobile phone. Nevertheless proximity based technology provides an exciting and secure method to perform a mobile commerce transaction.

### SUMMARY OF INVENTION

A system and method for mobile payment. The system and method provide for a user of a mobile telephony device (MTD), having an affixed wireless identification tag, to make payments, and other similar financial transactions, by presenting the MTD at a point-of-sale (POS), or equivalent, and by providing a confirmation, including a personal identification number, to complete the financial transaction via a data communication infrastructure (e.g. Unstructured Supplementary Service Data (USSD)) supported by the MTD.

The MTD has affixed to it a wireless identification tag (e.g. a radio frequency identification (RFID) tag) that allows the MTD to be uniquely identified by an identification tag reader that is co-located with a POS system (e.g. a cash register). The POS system sends an identification number obtained, by the reader, from the identification tag affixed to the MTD together with the currency value of a financial transaction (e.g. a purchase amount) to be completed and a merchant identification number to a transaction treatment platform (TTP). The TTP sends a request for confirmation, of the transaction and of the payment amount, to the user's MTD via mobile network data communications infrastructure. The user can confirm (i.e. authorize) the transaction by responding to the request and by including a personal identification number (PIN) or other similar identifier. Upon receiving a confirmation from the user, the TTP can complete the financial transaction by transferring the confirmed amount from an account associated with the user (e.g. a prepaid mobile telephony account) to an account associated with the merchant identification number (e.g. a merchant's bank account), and by sending confirmations that the transaction was successfully completed to the POS and to the user's MTD.

In accordance with one aspect of the present invention, there is provided a system for mobile payment from a user having a mobile telephony device (MTD) to a merchant having a point-of-sale (POS) system containing a merchant identification number (MIN), the system comprising: a wireless identification tag affixed to the MTD having encoded therein a user identification number (UIN) associated with the user; an identification tag reader for wirelessly reading the UIN encoded on the wireless identification tag when the MTD is proximate the POS system and for communicating the UIN to the POS system; one or more data repositories storing a first data record associating the MIN with a financial account belonging to the merchant (MFA) and a second data record associating the UIN with a financial account belonging to the user (UFA); and a transaction treatment platform adapted to: receiving, from the POS system, a transaction request comprising the UIN, a payment amount, and the MIN; authenticating the transaction by authenticating the MIN and the UIN, ensuring the UFA has sufficient credit to cover the payment amount, and obtaining a data communications address for the MTD by communicating with the one or more data repositories; sending a confirmation request, comprising the data communications address for the MTD, a confirmation message, the payment amount, UIN and MIN, to a data communications gateway for forwarding to the MTD; receiving, from the communications gateway, a confirmation reply comprising a PIN entered by the user, the data communications address for the MTD, the payment amount, UIN and MIN; authenticating the PIN and on successful authentication causing an amount equal to the payment amount to be transferred from the UFA to the MFA by communicating with the one or more data repositories; and sending a first success message to the POS system and sending a second success message to the MTD.

In accordance with another aspect of the present invention, there is provided a method for mobile payment from a user having a mobile telephony device (MTD) to a merchant having a point-of-sale (POS) system, the method comprising the steps of: registering the merchant by assigning a merchant identification number (MIN), entering the MIN into the POS system, and creating a data record in a data repository associating the MIN with a financial account belonging to the merchant (MFA); registering the user by assigning a user identification number (UIN), encoding the UIN is a wireless identification tag affixed to the MTD, creating a data record in the data repository associating the UIN with a financial account belonging to the user (UFA); initiating a payment transaction by the user placing the MTD proximate the POS system and by a identification tag reader connected with the POS system wirelessly reading the UIN encoded on the identification tag affixed to the MTD; submitting, from the POS system to a transaction treatment platform (TTP), a transaction request comprising the UIN, a payment amount, and the MIN; authenticating the transaction by authenticating the MIN and the UIN, ensuring the UFA has sufficient credit to cover the payment amount, and obtaining a data communications address for the MTD; sending a confirmation request, comprising the data communications address for the MTD, a confirmation message, the payment amount, UIN and MIN, to a data communications gateway; sending the confirmation message to the MTD; receiving the confirmation message at the MTD and the user confirming the payment transaction by entering a personal identification number (PIN); sending a confirmation reply comprising the PIN, the data communications address for the MTD, the payment amount, UIN and MIN; authenticating the PIN and on successful authentication causing an amount equal to the payment amount to be transferred from the UFA to the MFA; and sending a first success message to the POS system and sending a second success message to the MTD.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1 is a schematic representation of an exemplary system for mobile payment including an exemplary environment in which the system can be used.

FIG. 2 is a flow diagram of steps in an exemplary method for mobile payment.

FIG. 3 is a schematic representation of the mobile telephony device with a wireless identification tag.

### DETAILED DESCRIPTION

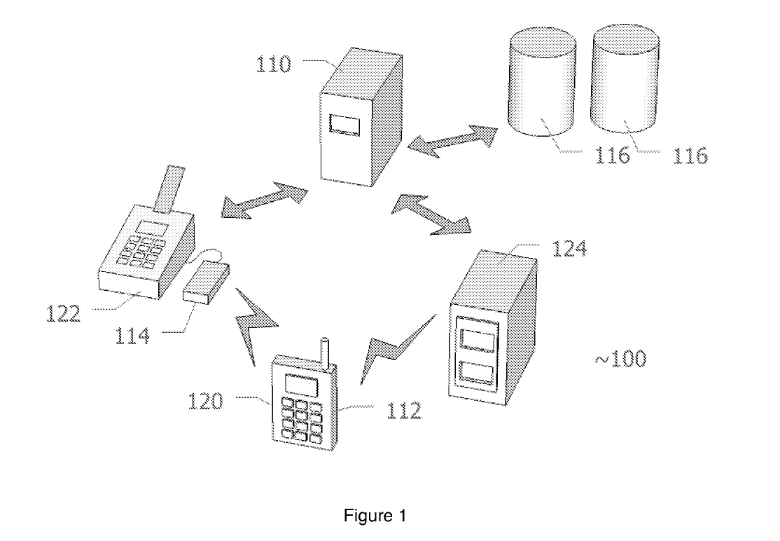

FIG. 1 is a schematic representation of an exemplary system 100 for mobile payment including an exemplary environment in which the system 100 can be used. The system 100 comprises a transaction treatment platform (TTP) 110, one or more wireless identification tags 112, one or more identification tag readers 114, and one or more data repositories 116. The environment comprises one or more mobile telephony devices (MTD), one or more point-of-sale (POS) systems 122, and one or more gateways 124.

Operation of the system 100 will be describer using an illustrative example mobile payment transaction. A user of a MTD wishes to purchase one or more products or services from a merchant. The merchant uses a POS system 122 to calculate a total purchase amount, or alternatively enters the total purchase amount into the POS system 122. The user identifies himself (or herself) by holding his (or her) MTD, that has a wireless identification tag 112 affixed thereto, proximate to an identification tag reader 114 connected to the POS system 122. The POS system 122 submits a transaction message containing a merchant identification number, an identification number read from the MTD (i.e. a user identification number) and the purchase amount to a TTP 110. The TTP 110 communicates with one or more data repositories 116 to authenticate the merchant identification number and the user identification number, to obtain an indication that the balance of a financial account associated with the user identification number is sufficient to cover the purchase amount, and to obtain a MSISDN associated with the user's MTD. If the user's account balance is sufficient to cover the purchase amount, the TTP 110 sends a confirmation request containing the MSISDN associated with the MTD, a confirmation message and transaction information from the transaction message to the gateway 124. The gateway 124 forwards the confirmation message to the MTD. Upon receiving the confirmation message at the MTD, the user can confirm the transaction by entering a personal identification number (PIN) that is sent back to the gateway 124. The gateway 124 sends a confirmation reply containing the PIN, the MSISDN and the transaction information to the TTP 110. The TTP 110 validates the PIN by communicating with a data repository 116. If the PIN is successfully validated, the purchase amount is transferred from the user's financial account to a financial account associated with the merchant identification number. On successful completion of the transaction, a confirmation message is sent from the TTP 110 to the POS system 122 and from the TTP 110 to the MTD via the gateway 124. Each of the messages describe in this paragraph are in the form of well known data communications messages.

Referring again to FIG. 1, each of the one or more identification tags 112 provides for a unique identification number to be read wirelessly when the identification tag 112 is in proximity to any one of the identification readers. In a preferred embodiment, the identification number is encrypted so that the actual identification number can not be readily ascertained by reading the identification tag 112 or by intercepting the read identification number when it is transited. Each unique identification tag 112 is associated with a different one of the MTD. The identification tags 112 can, for example, be well-known radio frequency identification (RFID) tags. The identification tags 112 are preferably passive RFID tags that can be affixed to a battery of the MTD under a battery cover. Affixing of the identification tag 112 under the battery cover provides a secure and inconspicuous location. The user is assured of having the identification tag 112 available whenever he/she has their MTD with them.

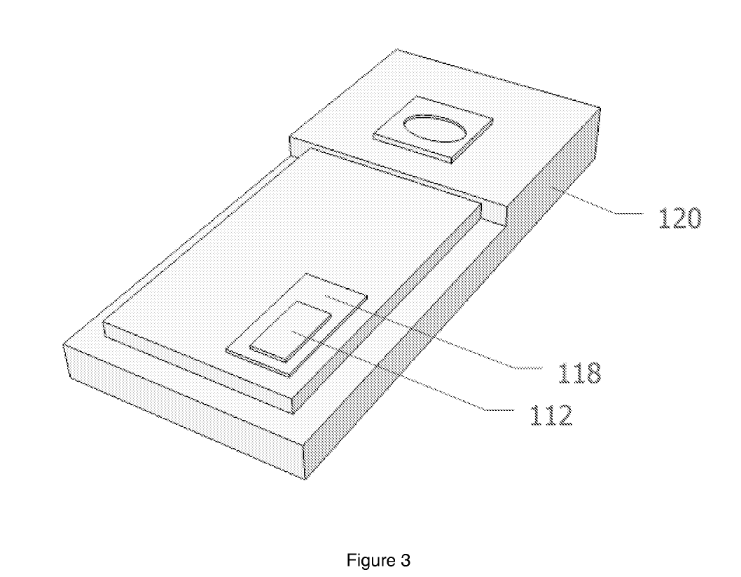

FIG. 3 is a schematic representation of the MTD 120 with a wireless identification tag 112. Metal contained in the MTD 120 battery can interfere with the operation of a typical RFID tag 112. In a further preferred embodiment, a high-frequency insulation layer 118 (e.g. a silicon elastomer developed by Emerson & Cumming Microwave Products Inc. of Randolph, Mass. USA) is installed between the RFID tag 112 and the MTD 120 battery to mitigate the interference. The RFID tag 112 can be used with any type of MTD 120 and is not dependent on the mobile technology (e.g. Global System for Mobile Communications (GSM), Code Division Multiple Access (CDMA), Time Division Multiple Access (TDMA)) supported by the MTD.

In an alternative embodiment the identification tags 112 can, for example, be a ZigBee® device that is affixed to the MTD. A ZigBee® device is a low-power digital radio device certified in accordance with the ZigBee® Alliance. In a preferred embodiment the ZigBee® device can be incorporated into a Subscriber Identity Module (SIM) for use in the MTD. When the ZigBee® device is incorporated into the SIM, power for the device can be obtained through the SIM connection to the MTD. Typically, GSM capable MTD include support for a SIM.

Each of the one or more MTD can, for example, be a mobile (a.k.a. cellular) phone associated with (e.g. belonging to) a subscriber on a mobile telephony network provided by a network operator. Each MTD has a unique associated MSISDN assigned by the network operator and also supports data communication using the Unstructured Supplementary Service Data (USSD) protocol. USSD is a capability of virtually all Global System for Mobile communications (GSM) mobile phones. In an alternative embodiment, a non-GSM based MTD (e.g. CDMA-based) can use another low-latency (i.e. not a store and forward) wireless data communications infrastructure having capabilities similar to USSD.

Each of the one or more identification tag readers 114 can read an identification number from an identification tag 112 that is in proximity to the reader. The placing of an identification tag 112 (e.g. an identification tag 112 affixed to a MTD as described above) in close proximity to (e.g. in contact with) a surface of the identification reader so that an identification number can be read is also known as ‘Tap and Go’. Each identification tag reader 114 is attached to one of the POS systems 122 for communicating the identification number read by the reader to the POS system 122. The identification tag readers 114 can, for example, be a well-known RFID tag reader 114, preferably capable of reading passive RFID tags. In alternative embodiment where the identification tag 112 is a ZigBee® device, the identification tag readers 114 can also be a ZigBee® device adapted to reading the identification number from the identification tag 112 ZigBee® device. In a further alternative embodiment, the identification tag reader 114 can be incorporated into the POS system 122.

Each of the one or more POS systems 122 is any well-known POS system 122 having the capability to connection to and receiving data communications from an identification tag reader, and to exchanging data communications with a TTP 110. Each POS system 122 has an associated merchant number, is adapted to processing commercial transactions that result in a purchase amount that is denominated in currency units (e.g. dollars, Euros, pounds Sterling), and provides for data communication with the TTP 110. Each POS system 122 preferably supports communications with the TTP 110 using Hypertext Transfer Protocol (HTTP). In an alternative embodiment the POS system 122 can be a MTD (i.e. a mobile phone) adapted to providing the POS capabilities described above.

The TTP 110 is a system for processing transactions, the processing includes exchanging data communications with the one or more POS systems 122, with the one or more data repositories 116, and with the one or more gateways 124. The TTP 110 contains transaction processing logic for directing and controlling transaction processing. The TTP 110 can, for example, comprise a well-known computing platform and computer executable instructions stored on a computer readable storage medium.

Each of the one or more data repositories 116 is adapted to storing, retrieving, updating and deleting information in a machine-readable format. Each of the data repositories 116 can be dedicated to supporting the TTP 110 or alternatively can provide support to the TTP 110 in addition to one or more other systems. The data repositories 116 can include for example, a mobile transaction database, a network operator database, and a financial institution (e.g. bank) database. Each of the data repositories 116 can be provided by any of a network operator, financial institution, the system 100 operator and other similar sources of data. Support provided to the TTP 110 by each data repository 116 includes locating and returning information contained in one or more data stores based on one or more keys (i.e. data items) provided by the TTP 110. The TTP 110 can determine from which of the one or more data repositories 116 to request information. Responsive to a data query from the TTP 110 containing a merchant identification number, a data repository 116 can return an authentication indicator (e.g. validate or invalid) for the merchant identification number and a merchant financial account identifier (e.g. number) associated with the merchant identification number. Responsive to a data query from the TTP 110 containing a user identification number, a data repository 116 can return an authentication indicator (e.g. validate or invalid) for the user identification number and a user financial account identifier (e.g. number) associated with the user identification number. Responsive to a data query from the TTP 110 containing a user identification number, a data repository 116 can return a MSISDN associated with the user identification number. Responsive to a data query from the TTP 110 containing a financial account identifier and a PIN, a data repository 116 can return an authentication indicator (e.g. validate or invalid). Further, the TTP 110 can, by providing a merchant financial account identifier, a user financial account identifier and a valid PIN, request from the one or more data repositories 116 that funds in the amount of the transaction amount be transferred from an account associated the user financial account identifier to an account associated with the merchant financial account identifier.

Each of the one or more gateways 124 can receive a confirmation request containing a MSISDN, a confirmation message, and transaction information in HTTP format from the TTP 110, and forward the confirmation message in USSD protocol format to the MTD associated with the MSISDN contained in the transaction information. Each gateway 124 can also receive a confirmation reply including a PIN from the MTD in USSD protocol format, and send a confirmation reply containing the MSISDN, PIN and transaction information to the TTP 110 in HTTP format. Each gateway 124 can receive a success message from the TTP 110 in HTTP format and forward the success message to the MTD in USSD protocol format. Each of the one or more gateways 124 can be a well-known USSD gateway 124 as is commonly used in GSM communication networks. In an alternative embodiment, in a non-GSM based mobile network (e.g. CDMA-based) the gateway 124 can use another low-latency (i.e. not a store and forward) data communications infrastructure having capabilities similar to USSD.

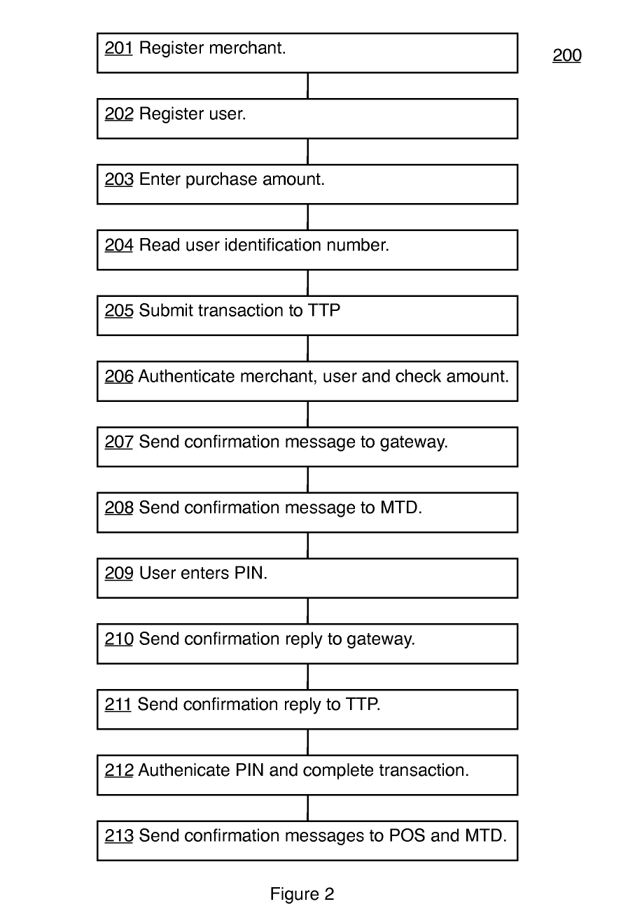

FIG. 2 is a flow diagram of exemplary steps in a method for mobile payment. The method can, for example, be implemented using the system 100 described above with reference to FIG. 1. In step 201, a merchant is registered by assigning a merchant identification number, and associating a financial account (e.g. bank account) with the merchant identification number. The merchant identification number is entered into the merchant's POS system 122 and a data record associating the financial account with merchant identification number is created in at least one of the data repositories 116. In step 202, a user is registered by assigning a user identification number, and associating a financial account (e.g. bank account) with the user identification number. The user identification number is encoded onto an identification tag 112 that is affixed to the user's MTD and a data record associating the financial account with user identification number is created in at least one of the data repositories 116. In step 203, the user wishes to make a purchase of products or services from the merchant and the purchase amount is enterer into, or calculated by, the merchant's POS. In step 204, the user places his MTD, having the affixed identification tag 112, near (i.e. proximate) the identification tag reader so that the encoded identification number can be read and transferred to the POS system 122. In step 205, the POS system 122 submits a transaction request to the TTP 110. The transaction request contains the user's identification number (i.e. the encoded identification number read from the identification tag 112 affixed to the user's MTD), the purchase amount, and the merchant's identification number. In step 206, the TTP 110 authenticates the merchant's identification number and the user's identification number, ensures that the user's financial account has sufficient funds to cover the purchase amount, and obtains a MSISDN associated with the user's MTD by submitting an authentication transaction to the one of more data repositories 116. In step 207, the TTP 110 sends a confirmation request to one of gateways 124. The confirmation request contains the MSIDN obtained in step 206, a confirmation message, transaction information including the purchase amount, the user identification number, and the merchant identification number. The confirmation request can, for example, be sent using HTTP encoding. In step 208, the gateway 124 sends a confirmation request including the confirmation message to the MTD associated with the MSISDN. The confirmation request can, for example, be sent using the USSD protocol. In step 209, the user receives the confirmation message on his MTD and can confirm the purchase transaction by entering a PIN. In step 210, the MTD sends a confirmation reply including the PIN to the gateway 124. The confirmation reply can, for example, be sent using the USSD protocol. In step 211, the gateway 124 sends a confirmation reply including the PIN, MSISDN and transaction information to the TTP 110. The confirmation reply can, for example, be send using HTTP encoding. In step 212, the TTP 110 authenticates the PIN by submitting an authentication request to one of the data repositories 116 and on successful authentication of the PIN causes an amount equal to the purchase amount to be transferred from the financial account associated with the user identification number to the financial account associated with the merchant's identification number. In step 213, a first success message is sent from the TTP 110 to the POS, and a second success message is sent from the TTP 110 to the MTD via the gateway 124.

The method according to the present invention can be implemented by a computer program product comprising computer executable program instructions stored on a computer-readable storage medium.

It will be apparent to one skilled in the art that numerous modifications and departures from the specific embodiments described herein may be made without departing from the spirit and scope of the present invention.

1. A system for mobile payment from a user having a mobile telephony device (MTD) to a merchant having a point-of-sale (POS) system containing a merchant identification number (MIN), the system comprising:
a wireless identification tag affixed to the MTD having encoded therein a user identification number (UIN) associated with the user;
an identification tag reader for wirelessly reading the UIN encoded on the wireless identification tag when the MTD is proximate the POS system and for communicating the UIN to the POS system;
one or more data repositories storing a first data record associating the MIN with a financial account belonging to the merchant (MFA) and a second data record associating the UIN with a financial account belonging to the user (UFA); and
a transaction treatment platform adapted to:
receiving, from the POS system, a transaction request comprising the UIN, a payment amount, and the MIN;
authenticating the transaction by authenticating the MIN and the UIN, ensuring the UFA has sufficient credit to cover the payment amount, and obtaining a data communications address for the MTD by communicating with the one or more data repositories;
sending a confirmation request, comprising the data communications address for the MTD, a confirmation message, the payment amount, UIN and MIN, to a data communications gateway for forwarding to the MTD;
receiving, from the communications gateway, a confirmation reply comprising a PIN entered by the user, the data communications address for the MTD, the payment amount, UIN and MIN;
authenticating the PIN and on successful authentication causing an amount equal to the payment amount to be transferred from the UFA to the MFA by communicating with the one or more data repositories; and
sending a first success message to the POS system and sending a second success message to the MTD.

2. The system of claim 1, wherein the wireless identification tag is one of a radio frequency identification (RFID) tag, and a ZigBee® device.

3. The system of claim 1, further comprising a high-frequency insulation layer installed between the wireless identification tag and the MTD, wherein the high-frequency insulation layer mitigates interference with the wireless identification tag caused by metal in the MTD.

4. The system of claim 1, wherein the wireless identification tag is incorporated into a subscriber identity module (SIM) for installation in the MTD.

5. The system of claim 1, wherein the identification tag reader is incorporated into the POS system.

6. The system of claim 1, wherein the data communications gateway is an Unstructured Supplementary Service Data (USSD) gateway.

7. The system of claim 1, wherein communication between the data communications gateway and the MTD is via a low-latency wireless data communications infrastructure.

8. The system of claim 1, wherein the POS system is a mobile telephony device.

9. A method for mobile payment from a user having a mobile telephony device (MTD) to a merchant having a point-of-sale (POS) system, the method comprising the steps of:
registering the merchant by assigning a merchant identification number (MIN), entering the MIN into the POS system, and creating a data record in a data repository associating the MIN with a financial account belonging to the merchant (MFA);
registering the user by assigning a user identification number (UIN), encoding the UIN is a wireless identification tag affixed to the MTD, creating a data record in the data repository associating the UIN with a financial account belonging to the user (UFA);
initiating a payment transaction by the user placing the MTD proximate the POS system and by a identification tag reader connected with the POS system wirelessly reading the UIN encoded on the identification tag affixed to the MTD;
submitting, from the POS system to a transaction treatment platform (TTP), a transaction request comprising the UIN, a payment amount, and the MIN;
authenticating the transaction by authenticating the MIN and the UIN, ensuring the UFA has sufficient credit to cover the payment amount, and obtaining a data communications address for the MTD;
sending a confirmation request, comprising the data communications address for the MTD, a confirmation message, the payment amount, UIN and MIN, to a data communications gateway;
sending the confirmation message to the MTD;
receiving the confirmation message at the MTD and the user confirming the payment transaction by entering a personal identification number (PIN);
sending a confirmation reply comprising the PIN, the data communications address for the MTD, the payment amount, UIN and MIN;
authenticating the PIN and on successful authentication causing an amount equal to the payment amount to be transferred from the UFA to the MFA; and
sending a first success message to the POS system and sending a second success message to the MTD.

10. The method of claim 9, wherein the wireless identification tag is one of a radio frequency identification (RFID) tag, and a ZigBee® device.

11. The method of claim 9, further comprising a high-frequency insulation layer installed between the wireless identification tag and the MTD, wherein the high-frequency insulation layer mitigates interference with the wireless identification tag caused by metal in the MTD.

12. The method of claim 9, wherein the wireless identification tag is incorporated into a subscriber identity module (SIM) for installation in the MTD.

13. The method of claim 9, wherein the identification tag reader is incorporated into the POS system.

14. The method of claim 9, wherein the data communications gateway is an Unstructured Supplementary Service Data (USSD) gateway.

15. The method of claim 9, wherein communication between the data communications gateway and the MTD is via a low-latency wireless data communications infrastructure.

16. The method of claim 9, wherein the POS system is a mobile telephony device.
